(19) United States
(12) Patent Application Publication
(10) Pub. No.: US 2009/0314378 A1
(43) Pub. Date: Dec. 24, 2009

(54) Airbag Fabric

(75) Inventors: Norbert Huber, Bad Säckingen (DE); Jörg Ruschulte, Richkenbach (DE); Thomas Eschbach, Rheinheim (DE); Thomas Gerspach, Bad Sackingen (DE)

Correspondence Address: HARNESS, DICKEY & PIERCE, P.L.C., P.O. BOX 828, BLOOMFIELD HILLS, MI, 48303, US

(73) Assignee: ITG Automotive Safety Textiles GmbH, Maulburg (DE)

(21) Appl. No.: 12/226,198

(22) PCT Filed: Apr. 12, 2007
(86) PCT No.: PCT/EP2007/003265

§ 371 Date: Aug. 17, 2009

(30) Foreign Application Priority Data
Apr. 12, 2006 (DE) 10 2006 017 272.8
May 12, 2006 (DE) 10 2006 022 560.0

(51) Int. Cl. B60R 21/235; D03D 1/02

(52) U.S. Cl. 139/389; 139/420 R

(57) ABSTRACT

Fabric for an airbag, comprising warp threads and weft threads, in particular using multifilaments, characterized by a weave density greater than the 95% Professor Walz standard. It can also have a permeability (LD) of less than 3 l/dm²/min (at 500 Pa differential pressure) pursuant to ISO 9237, and can be characterized by a warp/weft insertion ratio greater than 1.

### CROSS-REFERENCE TO RELATED APPLICATIONS

This application is a U.S. National Stage Application of International application No. PCT/EP2007/003265, filed Apr. 12, 2007. This application claims the benefit of German Application Nos. DE 10 2006 017 272.8, filed Apr. 12, 2006 and DE 10 2006 022 560.0, filed May 12, 2006. The disclosures of the above applications are incorporated herein by reference.

### BACKGROUND AND SUMMARY

The present invention relates to a fabric for airbag restraint systems both for conventionally stitched airbags and for one-piece woven (OPW) bags.

Known from EP 1 463 655 A1 (Milliken) is an airbag cushion made of a low tenacity polyester fabric (60 to 40 cN/tex). The airbag cushion is coated and finished with a circumferential seam configured either as a double or tri-stitch foldover seam. The object is to solve escape of the gas because of a seam leakage by a novel seam structural, employing a low tenacity coated PES fabric for the wall of the bag.

Known from DE 100 49 395 A (BST) is a textile sheet fabric for use in a passenger restraint system containing plastic deformable threads which when loaded in at least one surface direction permit an increase in the fabric surface and which is provided with a special elastic coating featuring a constant permeability.

Although the textile surface when incorporated in the walls of an airbag is adequately dimensioned as regards loading due to heat and pressure in a crash situation, it is the stitched seam that proves to be the weak point by it expanding in a crash, exposing the basic fabric under the coating which may result in an uncontrolled escape of hot gas in conjunction with scorching of the fabric.

Currently, use is made among other things of airbag fabrics which, especially in application as front airbag systems, need to be coated, the purpose of which is to seal off the airbag fabric from gas leakage, i.e. by the coating reducing the pore size and thus passage of the gas.

In application of an airbag system inflators are used, among other things, to deploy the airbag by jetting very hot gas into the airbag. It is particularly because of the high temperatures that a coating may be provided to elevate the thermal capacity of the airbag material which by absorbing part of the thermal energy protects it from become scorched. Employing coatings, particularly the usual silicone coatings increases the friction of the fabric which may prove to negatively influence the deployment response.

On top of this, coated fabric is very difficult to recycle, greatly adding to the costs for its disposal.

Applying a coating is highly complicated and not without critical aspects including, among other things, a striped finish as may result from faults in the coating paste, the supporting fabric, the coating process, etc. These stripes materialize from differences in the concentration of the coating. To counteract this, the concentration of the coating needs to be increased overall to satisfy the necessary minimum concentration also in the striped areas in which the process automatically results in the concentration being lower. All in all the coating process is highly cost-intensive, adding substantially to the cost of the airbag material.

The seam and the wall of an airbag are structural elements which as a rule are made of the same fabric. To harmonize the differing requirements for the same specification, complicated seaming structures are needed to adapt the “weakpoint seam” to the wall performance of the bag.

Another drawback is the escape of hot gas through the circumferential seam of front and driver airbags, posing the risk of underarm burns to the driver.

The wanted filter effect of the wall fabric of an airbag is greatly diminished due to the escape of gas through the seam, i.e. the wall surface is less stressed than would be possible physically. As compared to the unreliable functioning of the seam the performance of the wall areas is overdimensioned, making for poor economy. Also as regards its dynamic loading the airbag lacks optimum structural when employing the known fabric featuring high tenacity yarns.

The invention has the object of proposing a fabric of the aforementioned kind which avoids, or at least greatly diminishes, the drawbacks as known from prior art.

### DETAILED DESCRIPTION

### First Achievement

This object is achieved by a fabric as set forth in claim 1. The fabric in accordance with the invention for an airbag, comprising warp threads and weft threads, particularly of multi-filaments, is characterized by a cover factor (DG %) greater than 95% the WALZ density (the cover factor as defined by one Prof. Walz in the papers entitled “Die Gewebedichte I” and “Die-Gewebedichte II” published in the German textbook “Textilpraxis” in 1947, pages 330 to 366, by the publishing house Robert Kohlhammer, in Stuttgart, Germany). Calculating the cover factor DG requires determining the dtex, set and knowledge of the density of the fiber material employed.

Cover factor DG % as determined by Prof. Walz:

Cover factor DG %=(dₖ+dₛ)²·fₖ·fₛ

where:
dₖ/dₛ=substance diameter of warp and weft yarn respectively in mm
fₖ/fₛ=warp threads and weft threads per cm
The substance diameter of the yarns is given by

$${d}_{ks} = \frac{√ {dtex}_{ks}}{88 \text{,} 5 \cdot √ density g \text{/} {cm}^{3}}$$

Note: the above formula applies only for plain weaves: other weaves require the calculated cover factor to be multiplied by certain factors (e.g. twill 2:1=0.70, twill 2:2=0.56, twill 3:1=0.56, twill 4:4=0.38, satin 1:4=0.49, basket 2.2=0.56

Assuming the warp and weft threads of a fabric to be round, smooth and cylindrical makes for a density (set, thread count per cm) in which the threads just come into contact with each other without there being any appreciable spacing and without the one deforming the other. This condition is termed 100% as regards the cover factor.

A few special terms are used in the following description as briefly explained below:

All terms “bag”, “airbag”, “side airbag” or “air cushion” always mean the same thing.
“bag wall” denominates the wall(s) of an airbag.
“fabric stretch” is for the person skilled in the art of weaving a well known truism meaning a parameter as a function of the material/structural stretch involved.

The term “set” describes the type of material involved and yarn fineness and the structural warp/weft thread densities.

Yarn fineness: is as defined by DIN ISO 2060
Thread density: is as defined by DIN EN 1049
Crimp warp/weft: is as defined by DIN 53852
Edge comb resistance: is as defined by ASTM-D 6479

### (ASTM=American Society for Testing and Materials)

Making use of the high-density fabric in accordance with the invention now makes it possible to produce reliably functioning airbags without requiring a coating. This makes for enormous savings in the costs of producing airbags both as stitched and as OPW airbags.

In one alternative aspect of the invention the fabric has a permeability (LD) as per ISO 9237 of smaller than 3 l/dm²/min, preferably smaller than 1 l/dm²/min (for a differential pressure of 500 Pa). This achieves an improvement in the controlled escape of the gas, especially in conjunction with high-tenacity yarns.

In another particularly preferred alternative aspect of the invention the fabric has a crimp ratio of warp thread to weft thread greater than 1. The resulting greater crimp in the warp direction of the fabric achieves to advantage stronger structural stretching in the warp direction.

In another alternative aspect of the invention the fabric features an edge comb resistance greater than 700N in the warp direction or weft direction. The edge comb resistance is an indicator of the tenacity of the seam and thus also a measure to the opening of the seam. The edge comb resistance is tested in accordance with ASTM-D 6479 as dictated by the stiction between the two warp and weft thread systems at their points of intersection. The higher the stiction between warp and weft the greater is the resistance to the fabric structurally shifting out of place and the greater is the edge comb resistance. The high edge comb resistance in accordance with the invention thus advantageously results in a high seam tenacity.

The higher crimp of the warp permits achieving a high cover factor in conjunction with the low permeability LD, the crimp defining the shortening of the yarn material in the woven structure by the crimp of the thread in the warp and/or weft direction. The difference in the crimp is achieved by precisely setting the warp tension to a lower level, it being known that the crimp increases with the reduction in the warp tension. In addition, by setting the crimp any difference between the fabric stretch in the warp/weft direction can be compensated so that the difference in the material stretch in the warp/weft direction resulting from subtraction of each crimp from each fabric stretch is at a very low level. Combining these parameters results in a lower seam opening in the airbag, be it conventionally stitched or with a woven seam, for one thing due to the high edge comb resistance (reduction of the opening in the fabric structural due to a shift in the location of the warp/weft thread) and, for another, due to high modulus of elasticity (reduction of the opening in the fabric structural due to a lesser lengthening of the thread system under load). Because of the smaller seam opening the leakage is, despite lack of seam sealing (e.g. coating) as can be used in making airbags, very low.

In yet another alternative aspect of the invention the fabric has an edge comb resistance greater than 750 N to greater than 900 N in the warp direction or weft direction with the benefits as already described.

### Second Achievement

The object is also achieved by a fabric for an airbag comprising warp threads and weft threads, particularly of multifilaments which is characterized by a pore/basis weight factor (PF), as defined below by the applicant, greater than 2700 as set forth in claim 15.

Calculating the pore/basis weight factor (PF):

$$P F = \frac{Pore count in fabric \times spec . surface area {weight}^{2}}{1 \text{,} 000 \text{,} 000}$$

where
pore count in fabric=(warp thread density−1)×(weft thread density−1)
warp/weft thread density=thread count per link (n/dm)
surface area weight=weight per unit of surface area (g/m²)

The advantages resulting from the fabric in accordance with the invention as materializing from claim 11 and the subsequent claims are the same as those as already recited for a fabric as set forth in any of the claims 1 to 10. Making use of the high-density fabric in accordance with the invention achieves to advantage the production of reliably functioning airbags without any coating, resulting in enormous savings in the costs of producing airbags both as stitched and as OPW airbags. The higher the pore/basis weight factor (PF) the better is the performance of an uncoated airbag.

The high-density fabric in accordance with the invention is suitable to hold back particles of the detonator released when implemented to deploy the airbag in thus preventing the risk of the vehicle occupants being scorched or injured thereby. In addition to this, using the fabric in accordance with the invention does away with the coating as an additional process in production, thus avoiding the potential for rejects as is usual in prior art, necessitating additional high cost monitoring and testing facilities. Here again, making use of the high-density fabric in accordance with the invention eliminates these extra costs.

A further advantage of the fabric in accordance with the invention results from its higher thermal capacity as compared to that of conventional airbag fabrics. The functioning of the conventional coating (providing additional thermal capacity) is more than compensated for by the high-density of the fabric.

In further advantageous aspects of the invention the fabric has a permeability LD in accordance with ISO 9237 smaller than 3 l/dm²/min and especially a warp/weft crimp ratio of better than 1 with the advantages as just described.

In yet another advantageous alternative aspect of the invention the fabric has a pore/basis weight factor (PF) of better than 2800, preferably better than 2900, in thus further enhancing the advantages as described above.

In still another advantageous alternative aspect of the invention the fabric is characterized in that crimping the warp threads is greater than crimping the weft threads, again with the advantages as described above.

In another advantageous alternative aspect of the invention the fabric is a high-density fabric comprising a cover factor of 100% in the raw fabric with low yarn tenacity.

In yet a further advantageous alternative aspect of the invention the fabric has a cover factor (DG) greater/equal to 110% with a high seam tenacity (edge comb resistance greater than 200N) for a LDPF (=Low Denier Per Filament) yarn (fine filamentary, denier smaller than 5 dtex/filament).

The invention now makes it possible to advantage to form a wealth of fabric variants with variable parameters, such as denier, tenacity 50 to 85 cN/tex, stretch, modulus of elasticity and working capacity in the yarn in accordance with requirements, as well as fabric featuring a stretch−relative to the material stretch−approaching the elastic (Hooke's) range at maximum internal pressure of the airbag, so that the fabric returns to its original density on collapse of the pressure.

The invention now makes it possible to fabricate uncoated airbag fabric with maximum possible cover factor from fine filament yarns, the fabric being symmetrically structured and featuring yarns of differing denier, differing in tenacity and stretch. It is to be noted that a reduction in tenacity likewise reduces the modulus of elasticity in boosting the working capacity. A cover factor of max. 100% is achieved in the raw and of max. 110% when finished, the aim generally being to minimize seam leakage by a high cover factor and high edge comb resistance. For this purpose, the wall of the bag is made of uncoated fabric of yarns differingly specified in accordance with the structure of the bag.

The achievement in accordance with the invention makes for a wealth of further advantages: for one thing, the higher seam tenacity, measured as edge comb resistance in N results in a controlled escape of gas through the wall of the bag and/or an adaptive vent in thus enhancing the protective effect. For another, the fabric in accordance with the invention now makes it possible for the designer to optimize engineering the airbag. The high-density of the fabric up to the limiting range of the cover factor makes for a higher structural stretch (crimp). Making use of low tenacity yarns, partly compensated in the surface by a higher thread count, increases the material stretch of the fabric, it responding more elastically due to its enhanced working capacity under dynamic loading conditions. All this, achieves a reduction in the production costs for yarn by a lower stretch and a reduction in the quality costs by a better yarn quality due to the lower stretch.

Example parameters of technical PA 6.6 yarn (dtex 470)

| | | standard | standard | modified | modifed |
|---|---|---|---|---|---|
| Parameter | unit | Type A | Type B | Type - A | Type - B |
| Tenacity | cN/tex | 76.3 | 80 | 60 | 50 |
| Stretch | % | 23 | 19 | 45 | 70 |
| Working | cN/tex | 360 | 348 | 400 | 420 |
| capacity | | | | | |
| Modulus of | cN/tex | 388 | 468 | 333 | 310 |
| elasticity | | | | | |
| Filament count | N | 144 | 140 | 144 | 144 |

To achieve a low permeability LD a yarn comprising a high filament count is needed, in other words a Low Denier Per Filament (LDPF) type, i.e. <5 dtex/filament.
The working capacity equates as follows:

Working capacity [cN/tex])=tenacity [cN/tex])×√stretch [%]

Example aspect of a fabric in accordance with the invention

The parameters of the fabric as listed below are an advanced calculation:

| | | dtex 470 | | | | dtex 700 | | | |
|---|---|---|---|---|---|---|---|---|---|
| | | yarn-type | yarn-type | | | yarn type | yarn type | | |
| | | standard | standard | | | standard | standard | | |
| | | high | super-high | yarn | yarn | high | super-high | yarn | yarn |
| Parameter | Unit | tenacity | tenacity | type A | type B | tenacity | tenacity | type A | type B |
| Structure | | | | | | | | | |
| warp | Fd/cm | 20 | 20 | 23 | 23 | 16 | 16 | 18 | 18 |
| weft | Fd/cm | 19 | 19 | 23 | 23 | 16 | 16 | 18 | 18 |
| Material | g/m² | 210 | 210 | 253 | 253 | 250 | 250 | 289 | 289 |
| weight | | | | | | | | | |
| Tenacity | | | | | | | | | |
| warp | N/5 cm | 3430 | 3760 | 3240 | 2700 | 4080 | 4480 | 3780 | 3150 |
| weft | N/5 cm | 3250 | 3570 | 3240 | 2700 | 4080 | 4480 | 3780 | 3150 |
| Useful weave | % | 95 | 95 | 97 | 98 | 95 | 95 | 97 | 98 |
| Weaving | % | 100 | 100 | 84 | 85 | 100 | 100 | 91 | 92 |
| output | | | | | | | | | |

The weave is a L1/1 plain weave throughout. As described above, this high-density uncoated fabric improves the seam seal in optimizing the escape of gas through the wall surfaces of the bag by increasing the permeability LD with increasing internal pressure for a controlled escape of the gas with a return to near zero on collapse of the pressure in keeping with the load. Such a particle holdback effect can only be controlled via the wall surfaces when the seam is tight.

Due to the need to engineer the textile bag to the vehicle concerned in each case, to the inflator being used as well as to the seam structure, the high-density fabric is engineered with types of yarn differing as to the tenacity, stretch and working capacity making for more room in optimizing the deployment response of the airbag as regards its textile-engineered structural.

For the same static permeability LD<1 1/dm²/min (for a differential pressure of 500 Pa) tenacity, stretch, working capacity and modulus of elasticity as well as seam structure can all be varied and optimized.

This particularly enables exploiting the stretch of the fabric composed of the structural and material stretch in the elastic (Hooke's) range—relative to the material stretch—in the sense of the loading equivalence.

The maximum cover factor in % as per WALZ (see above) is 110% in the finished fabric and roughly 100% in the raw fabric.

Overview of fabric structures in accordance with the invention (by way of example as to material/thread density and WALZ cover factor)

| | | raw | | | | finished | | | |
|---|---|---|---|---|---|---|---|---|---|
| | | standard | standard | invention | invention | standard | standard | invention | invention |
| | | 470 dtex | 700 dtex | 470 dtex | 700 dtex | 470 dtex | 700 dtex | 470 dtex | 700 dtex |
| parameter | unit | 20/19/cm | 16/16/cm | 23/23/cm | 18/18/cm | 20/19/cm | 16/16/cm | 23/23/cm | 18/18/cm |
| structural | | | | | | | | | |
| warp | (x/cm) | 18.9 | 15.2 | 21.9 | 17.9 | 20 | 16 | 23 | 18.7 |
| weft | (x/cm) | 18.7 | 15.7 | 21.9 | 17.9 | 19 | 16 | 23 | 18.7 |
| cover factor | | | | | | | | | |
| (DG) | (%) | 74 | 75 | 100 | 100 | 80 | 80 | 110 | 110 |

The fabric parameters stretch [%], tear strength [N], edge comb resistance [N], max tensile force [N/5 cm] and permeability LD [l/dm²/min] are tweaked by yarn selection as well as by corresponding production parameters in the weave and finishing process.

In accordance with the invention a PA 6.6 yarn (as cited above by way of example) with low tenacity in cN/tex can be employed simultaneously involving a higher material stretch, higher working capacity and lower maximum tensile force.

Likewise provided for in accordance with the invention is also a fabric structure featuring a maximum possible thread density (optimized cover factor).

In the uncoated condition the fabric has a low permeability of 1 l/dm²/min. With a corresponding bag internal pressure the fabric stretches because of its increased working capacity, resulting in the permeability LD becoming larger and at the same time the bag volume increases, reducing the internal pressure of the bag. A coated fabric performs similarly as regards working capacity and bag volume.

Depending on how elastic the coating is, the increase in the permeability LD or the profile of its curve as a function of the internal pressure differs and corresponding is the ratio as a laminated fabric warp stretch film, the stretch response of the bag walls resulting in a reduction in the internal pressure of the bag due to the increase in volume.

Making use of the fabric in accordance with the invention improves the ratio of

tenacity and working capacity of the bag wall/seam loading

in favour of an enhanced seam tightness, there being no uncontrolled escape of the inflator gas in the seam area of the fabric in accordance with the invention, unlike in prior art. This elimination in accordance with the invention enhances the particle holdback response of the airbag.

Although the production costs in the shop are increased despite these better useful effects due to the low delivery, this is more than compensated by the reduction in the quality costs, the improved quality of the yarn speeding up production. Comparing it to a standard fabric documents the requirements for optimization of the fabric this high-density fabric in accordance with the invention can be put to use in airbags uncoated, saving the costs of coating whilst improving recycling.

To conclude, two examples of a fabric in accordance with the invention (examples 1 and 2) are compared to two examples of conventional fabric (examples 5 and 6)

| | | Example No. | | | |
|---|---|---|---|---|---|
| | | 1 | 2 | 5 | 6 |
| Structural | | invention | invention | standard | standard |
| yarn fineness, warp | (dtex) | 235 | 470 | 235 | 470 |
| material density, warp | (g/cm³) | 1.15 | 1.15 | 1.15 | 1.15 |
| thread density, warp | (x/dm) | 316 | 220 | 285 | 200 |
| yarn fineness, weft | (dtex) | 235 | 470 | 235 | 470 |
| material density, weft | (g/cm³) | 1.15 | 1.15 | 1.15 | 1.15 |
| thread density, weft | (x/dm) | 316 | 220 | 285 | 190 |
| substance diameter, warp | | 0.16152574 | 0.228431892 | 0.16152574 | 0.22843189 |
| substance diameter, weft | | 0.16152574 | 0.228431892 | 0.16152574 | 0.22843189 |
| WALZ density of fabric | (%) | 104.2119775 | 101.0226669 | 84.768245 | 79.315317 |
| basis weight | (g/m²) | 171.5 | 243.9 | 155 | 210 |
| pore count | (x/dm²) | 99225 | 47961 | 80656 | 37611 |
| basis weight² | | 29412.25 | 59487.21 | 24025 | 44100 |
| PF pore-basis weight factor | (x) | 2918.430506 | 2853.066079 | 1937.7604 | 1658.6451 |
| crimp, warp | (%) | 10.2 | 9.5 | 6.46 | 6.6 |
| crimp, weft | (%) | 4.4 | 6.3 | 4.73 | 3.9 |
| Δ crimp warp/weft | (%) | 5.8 | 3.2 | 1.73 | 2.7 |
| fabric stretch, warp | (%) | 38.8 | 40.6 | 34.2 | 36.09 |
| fabric stretch, weft | (%) | 32.1 | 36.3 | 32.92 | 34.34 |
| material stretch, warp | (%) | 28.6 | 31.1 | 27.74 | 29.49 |
| material stretch, weft | (%) | 27.7 | 30 | 28.19 | 30.44 |
| Δ material stretch, warp/weft | (%) | 0.9 | 1.1 | −0.45 | −0.95 |
| edge comb resistance, warp | (N) | 715 | 895 | 632 | 511 |
| edge comb resistance, weft | (N) | 819 | 907 | 628 | 422 |

The invention claimed is:

1. An airbag fabric comprising warp threads and weft threads using multi-filaments, the fabric including a cover factor greater than 95% WALZ density.

2. The fabric as set forth in claim 1, including a permeability LD as per ISO 9237 smaller than 3 l/dm²/min (for a differential pressure of 500 Pa).

3. The fabric as set forth in claim 1 including, a warp/weft crimp ratio greater than 1.

4. The fabric as set forth in claim 1, wherein the fabric is uncoated.

5. The fabric as set forth in claim 1, including a cover factor greater than 100% WALZ density.

6. The fabric as set forth in claim 1, including an edge comb resistance greater than 700N in the warp or weft direction.

7. The fabric as set forth in claim 1, including an edge comb resistance greater than 750N in the warp or weft direction.

8. The fabric as set forth in claim 1, including an edge comb resistance greater than 800N in the warp or weft direction.

9. The fabric as set forth in claim 1, including an edge comb resistance greater than 850N in the warp or weft direction.

10. The fabric as set forth in claim 1, including an edge comb resistance greater than 900N in the warp or weft direction.

11. An airbag fabric comprising warp threads and weft threads using multi-filaments, the fabric including a pore/basis weight factor PF greater than 2700.

12. The fabric as set forth in claim 11, including a permeability LD as per ISO 9237 smaller than 3 l/dm²/min.

13. The fabric as set forth in claim 11, including a warp/weft crimp ratio greater than 1.

14. The fabric as set forth in claim 11, wherein the fabric is uncoated.

15. The fabric as set forth in claim 11, including a pore/basis weight factor greater than 2800.

16. The fabric as set forth in claim 11, including a pore/basis weight factor greater than 2900.

17. The fabric as set forth in claim 11, including an edge comb resistance greater than 700N in the warp or weft direction.

18. The fabric as set forth in claim 11, including an edge comb resistance greater than 750N in the warp or weft direction.

19. The fabric as set forth in claim 11, including an edge comb resistance greater than 800N in the warp or weft direction.

20. The fabric as set forth in claim 11, including an edge comb resistance greater than 850N in the warp or weft direction.

21. The fabric as set forth in claim 11, including an edge comb resistance greater than 900N in the warp or weft direction.

22. The fabric as set claim 11, wherein the crimp of the warp threads is greater than the crimp of the weft threads.
